(19) United States
(12) Patent Application Publication
(10) Pub. No.: US 2009/0022541 A1
(43) Pub. Date: Jan. 22, 2009

(54) PACKAGING AND APPLICATOR DEVICE INCLUDING A STIFFENER SUPPORTING A BLOCK OF AT LEAST ONE COMPOSITION

(75) Inventor: Vincent DE LAFORCADE, Rambouillet (FR)

Correspondence Address: OLIFF & BERRIDGE, PLC, P.O. BOX 320850, ALEXANDRIA, VA, 22320-4850, US

(73) Assignee: L'OREAL, Paris (FR)

(21) Appl. No.: 12/175,287

(22) Filed: Jul. 17, 2008

Related U.S. Application Data
(60) Provisional application No. 60/954,378, filed on Aug. 7, 2007.

(30) Foreign Application Priority Data
Jul. 19, 2007 (FR) 07 56628

(51) Int. Cl. B43K 23/00; B29C 39/10; A45D 40/26

(52) U.S. Cl. 401/98; 264/268; 264/490; 401/49; 132/200

(57) ABSTRACT

The present invention relates to a packaging and applicator device for applying at least one cosmetic composition, the device comprising:
a body defining a handle;
a block of at least one cosmetic composition;
a flat stiffener that is stationary relative to the composition and that extends inside said composition, the block defining a free outside surface that extends over at least a fraction of the height of the stiffener; and
a cap that is arranged so as to be fastened on the body, and so as to cover the block.

This non provisional application claims the benefit of French Application No. 07 56628 filed on Jul. 19, 2007 and U.S. Provisional Application No. 60/954,378 filed on Aug. 7, 2007.

The present invention relates to packaging and applicator devices for applying a cosmetic composition.

### BACKGROUND

Compositions for application to the lips can present a solid shape, in which event they are generally packaged in the form of a stick that is disposed in a mechanism that makes it possible to raise or lower it in a body that serves as a handle.

Such devices offer limited possibilities for modifying the shape of the stick, since the longer and thinner said stick, the greater the risk of it breaking during use, other than using formulae that are more compact, which might not be as comfortable in use as desired.

French patent application FR 2 168 625 discloses a makeup baton in which the composition is supported by a stem. Such a device is suitable for making a sample, but it is not suitable for repeated use.

French patent application FR 2 259 560 proposes packaging lipstick in the form of a ring of composition carried by a core. Such a device turns out to pose difficulties in industrial manufacturing, and remains relatively expensive.

US application No. 2006/0272661 discloses a device in which the composition is deposited on a support in order to make a sample. Such an applicator makes it possible to make use only of composition having a plane face, and that can adversely affect the precision with which makeup is applied.

European patent application EP 1 595 472 discloses a packaging and applicator device including a body and a block of fluidizable composition that, in its solid state, is stationary relative to the body, the block of composition projecting out from the body in such a manner as to define at least one surface that is used for application. A reshaping member can be positioned on the body in such a manner as to co-operate with said body to define at least one cavity in which the composition can flow when made fluid by applying heat, the composition conserving the shape of the cavity when it returns to its solid state after cooling.

French patent application FR 2 563 711 discloses a kit for applying a blusher, the kit including a stand that is provided with a fastener device for fastening the base of a block of blusher.

U.S. Pat. No. 3,332,429 discloses a kit for applying a cosmetic composition, the kit including a receptacle in which there is placed a block of cosmetic composition that is secured to a handle by means of fastener elements.

British patent application GE 2 158 043 discloses an applicator device for applying a lipstick, the device including a cone-shaped support for fastening a sample of a cosmetic composition.

U.S. Pat. No. 5,092,700 discloses a sampling article that includes a hollow body for filling the article with a cosmetic composition, and that is provided at one of its ends with a conical dome that is pierced with four openings via which the cosmetic flows during filling.

### SUMMARY

There exists a need to benefit from a novel way of packaging a cosmetic composition, including a care product, that is practical, relatively inexpensive, and suitable for cosmetic compositions that are relatively fragile mechanically, such as compositions for making-up the lips.

Exemplary embodiments of the present invention relate to a packaging and applicator device for applying at least one cosmetic composition, the device comprising:
a body defining a handle;
a block of at least one cosmetic composition;
a stiffener that is stationary relative to the composition and that extends inside said composition, the block defining a free outside surface that extends over at least a fraction of the height of the stiffener; and
a cap that is arranged so as to be fastened on the body, and so as to cover the block.

The stiffener may also be stationary relative to the body.

An outside surface that is said to be “free” should be understood to mean a surface that is not in contact with any covering wall while the device is being used.

By means of the invention, the composition can be applied without any constraint other than removing the protective cap.

The stiffener contributes to holding the composition mechanically, thereby enabling novel possibilities in terms of formulation, in particular it makes it possible to use a composition that is relatively fragile, without fear of the composition breaking during use.

The body may include a filler orifice in its side remote from the cap.

The device may include a stopper that is fastened in the filler orifice in optionally-removable manner.

The stiffener may advantageously be flat.

A flat shape may impart flexibility to the stiffener, where appropriate.

The stiffener may be perforated and/or it may include portions in relief that encourage the composition to cling onto the stiffener.

The stiffener may include a plurality of holes through which the composition passes.

Over at least a fraction of its height, the body may present an external cross-section that is oblong, but other shapes can be envisaged. By way of example, the body may present a generally flat shape.

The stiffener may be molded integrally with the body, e.g. out of a thermoplastic material.

The stiffener may present a height, measured between the base of the initial block of composition and the top edge of the stiffener, parallel to the longitudinal axis of the stiffener, that is greater than half the initial height of the block, preferably greater than 60%, better greater than 70%, better greater than 80%, still better greater than 90%.

When observed in face view, perpendicularly to its opposite main faces, the stiffener can be of shape that is: rectangular; square; oval; triangular; circular, in particular semi-circular; polygonal; amongst others.

The device may include a single stiffener. In particular, the device need not be provided with multiple stiffeners of identical or different shapes, distributed over the body of the device, for example. The body of the device may be secured to a single stiffener.

When the stiffener includes a plurality of holes, said holes may be circular in shape, and may be distributed over the stiffener, optionally in regular manner.

The cap may be independent of the other elements of the device, in particular of the body, and may be detachable therefrom.

At its base, the block of composition may present a plane surface that is perpendicular to the longitudinal axis of the stiffener.

The fraction of the stiffener that is covered by the block of composition in its initial shape may be wider than it is thick. In particular, the greatest width of the fraction of the stiffener that is covered by the block of composition in its initial shape may, at its base, be at least 30 times, better at least 40 times, better at least 50 times, still better at least 60 times greater than the greatest thickness of said fraction of the stiffener. The thickness of said fraction of the stiffener that is covered in composition may be constant throughout, except at the holes when the stiffener has any.

The stiffener may be symmetrical about a flattening plane of the stiffener passing via the longitudinal axis of the stiffener. The outline of the stiffener may be symmetrical about a mid-plane that is perpendicular to the flattening plane.

When the stiffener includes holes, all of the holes may open out on one side into a single plane that is parallel to the flattening plane of the stiffener, for example. All of the axes of the holes may be parallel to one another. The axes may also be perpendicular to the flattening plane of the stiffener. All of the holes may open out into the two opposite main faces of the stiffener. The two opposite faces of the stiffener may be plane.

Two adjacent holes may be spaced apart by a distance that is the same for all of the holes.

The thickness of the block of composition may optionally be constant all around the entire stiffener. In particular, the block of composition may be thicker at the opposite main faces of the stiffener, than over the edges of the stiffener, in particular when the block of composition is in its initial shape.

The device need not be circularly symmetrical.

The fastener zone for fastening the cap on the body of the device may be situated below the initial level of the base of the block of composition in its initial shape.

The cap may be arranged so as to rest in stable manner on a plane horizontal surface while in an upsidedown position. This makes it easier to reshape the block.

In a variant, the device may include a stand that is independent of the cap, and on which the cap can be placed upsidedown, in stable manner.

The block may be formed of a single composition, or, in a variant, it may comprise two different compositions, or even more.

One of the compositions may be colored and the other may be for imparting glossiness.

The two compositions may be disposed on respective sides of a mid-plane for the stiffener.

The stiffener need not be in contact with the cap, when said cap is in place on the body. In a variant, the stiffener may come into contact with the cap, when said cap is in place on the body, thereby making it possible to avoid the compositions mixing together, for example.

The composition(s) may be for application to the lips, to the skin, or to keratinous fibers.

The block of composition may advantageously be fluidizable by applying heat. By way of example, the composition has a melting temperature that is less than or equal to 60° C.

In another of its aspects, the invention also provides a manufacturing method in which, while the cap is upsidedown and in place on the body, at least one composition is poured in fluid state through the filler orifice of the body, the cap serving as a mold so as to give the composition its shape while cooling.

In particular, the body of the device may be filled via a filler orifice of axis that coincides with, or that is parallel to, the longitudinal axis of the stiffener.

The invention also provides a method of reshaping a block of at least one composition of a device as defined above, the method comprising the steps consisting in placing the cap upsidedown in place on the body, and in heating the composition so as to bring it to a temperature at which it becomes fluid, so that, on cooling, the composition takes on the shape of the cap. By way of example, heating may be performed by placing the device in a microwave oven.

Exposing the composition to microwaves may have a bactericidal effect.

The invention also provides a method of applying makeup to keratinous materials, in particular the lips, the method comprising the step consisting in bringing a surface of the block of composition of a device as defined above, into contact with the keratinous materials to be made up.

### BRIEF DESCRIPTION OF THE DRAWINGS

The invention can be better understood on reading the following detailed description of non-limiting embodiments thereof, and on examining the accompanying drawings, in which:

FIG. 1 is a diagram in longitudinal section showing an example of a device made in accordance with the invention;

FIG. 2 is a longitudinal section on II-II in FIG. 1;

FIG. 3 is a perspective view showing the body and the stiffener in isolation;

FIG. 4 is a perspective view of the body and of the stiffener from a different view point to the view point in FIG. 3;

FIG. 5 is a front view of the closed device;

FIG. 6 is a perspective view of the closed device;

FIG. 7 shows the device after the cap has been removed;

FIG. 8 is a side view of the device after the cap has been removed;

FIGS. 9 to 11 show how the appearance of the composition changes as it is being used up, and on reshaping the applicator surface;

FIG. 12 is a fragmentary section of a variant embodiment of the cap shown in isolation;

FIG. 13 shows the use of a stand for standing the cap upsidedown;

FIG. 14 is a view similar to FIG. 8 showing a variant embodiment; and

FIG. 15 is a fragmentary longitudinal section of a variant embodiment.

### MORE DETAILED DESCRIPTION

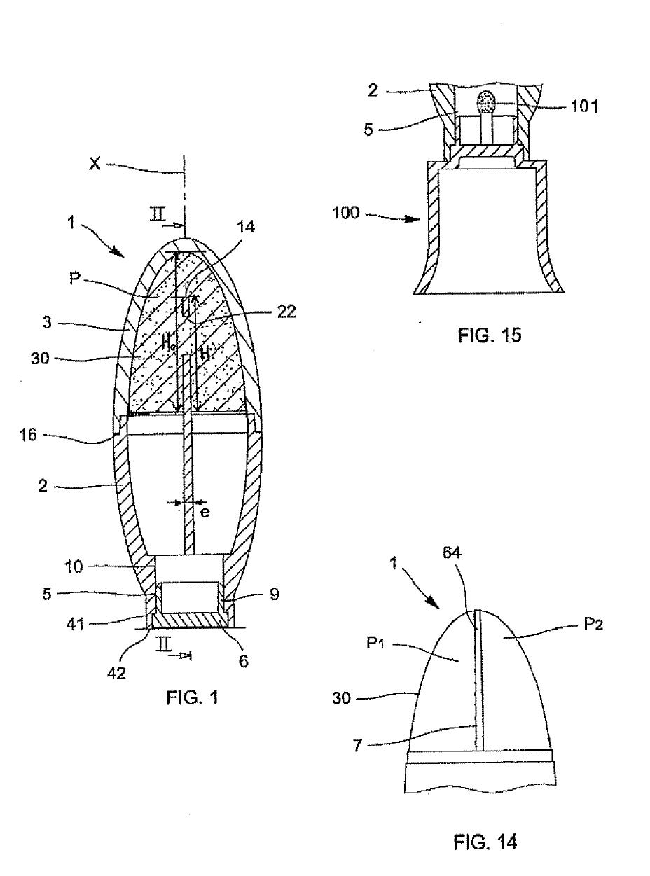

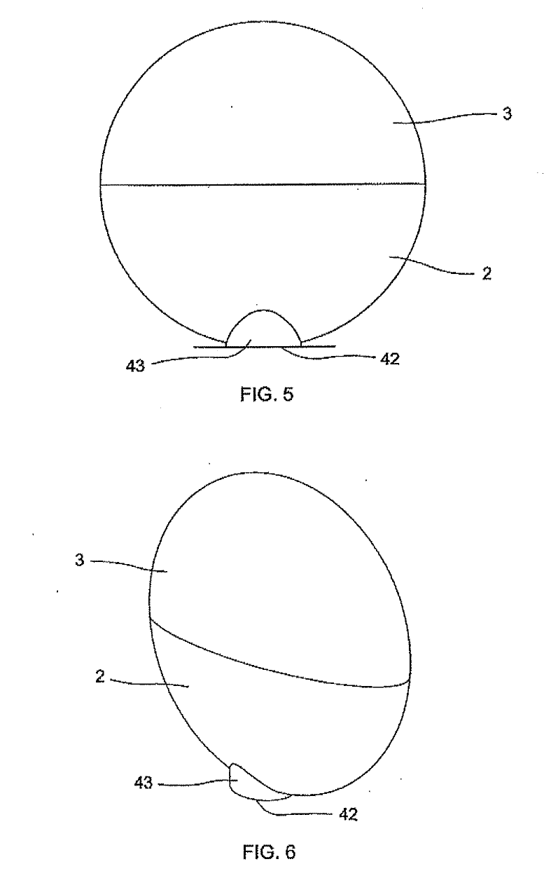

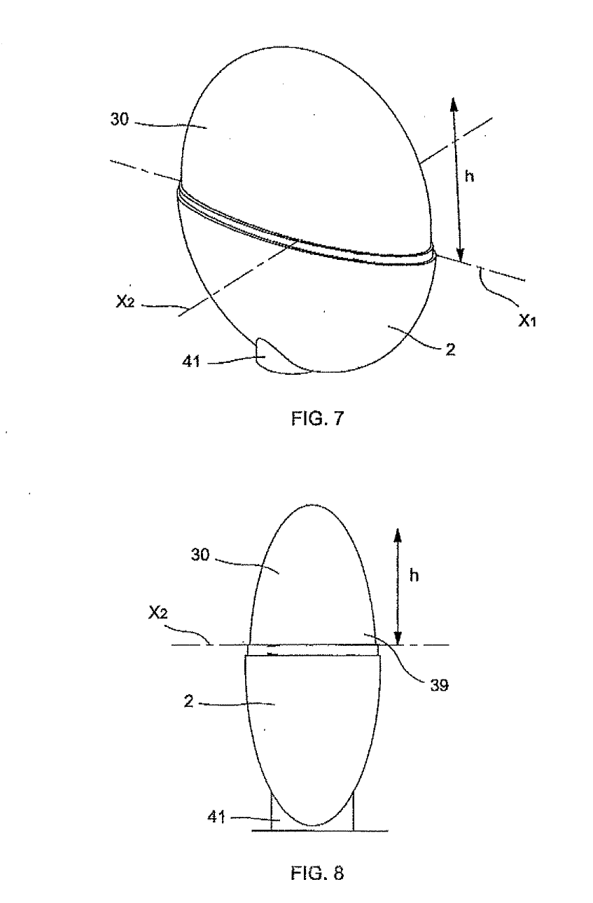

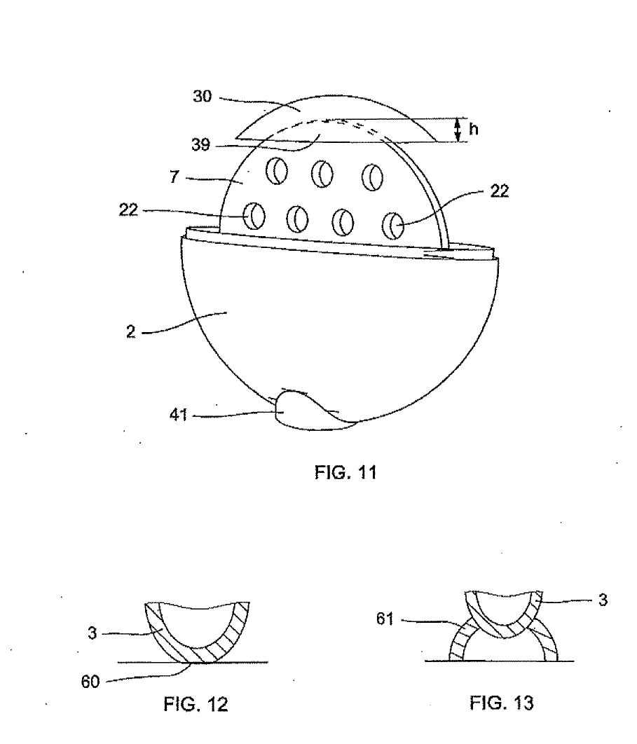

The packaging and applicator device 1 shown in FIGS. 1 to 11 includes a body 2 on which a protective cap 3 can be fastened.

In the embodiment under consideration, the body 2 includes a filler orifice 5 that is situated on the side remote from the cap 3, and that is closed by a stopper 6.

The device 1 also includes an inner stiffener 7 of longitudinal axis X and that is molded integrally with the body 2.

The cap 3 can be fastened on the body 2 in various ways, e.g. by friction or by snap-fastening, or even by screw-fastening if the shape of the cap permits it.

The stopper 6 can also be fastened on the body 2 in various ways, e.g. by friction, by snap-fastening, or by screw-fastening.

The stopper 6 can optionally be removable.

In the embodiment under consideration, the stopper 6 is removable and includes an annular sealing lip 9 that is bears in leaktight manner against a circularly cylindrical surface 10 of the filler orifice 5.

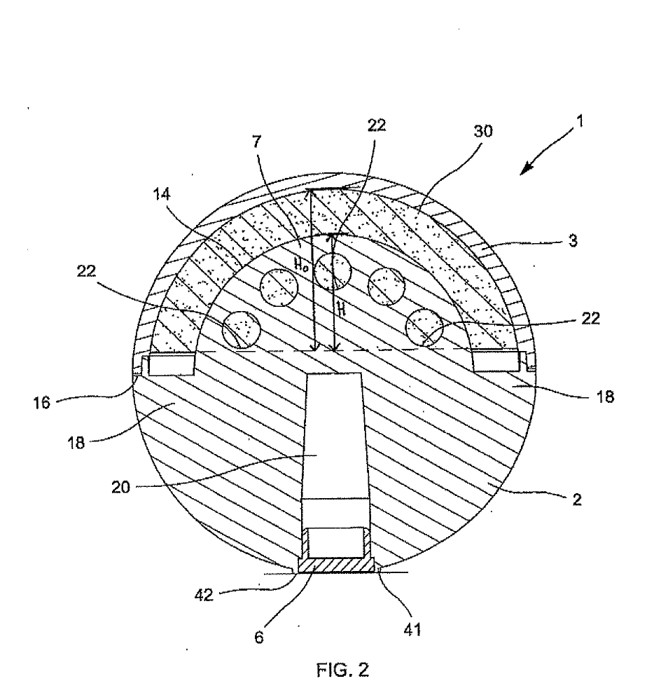

By way of example, the stiffener 7 presents a flat shape with a thickness e that can decrease slightly towards its top edge 14, for example, and that can, in front view, present a shape that is substantially semi-circular, as shown in FIG. 2.

The height H of the stiffener 7, measured between the base of the initial block 30 of composition and the top edge 14 of the stiffener 7, parallel to the longitudinal axis of the stiffener, can be greater than half the initial height H₀ of the block, preferably greater than 60%, better greater than 70%, better greater than 80%, still better greater than 90%, i.e. H≧0.5H₀, H≧0.6H₀, H≧0.7H₀, H≧0.8H₀, or H≧0.9H₀.

The top edge 14 of the stiffener 7 can be closer to the top end of the block 30 of composition than to its base in its initial shape.

The body 2 can include a step 16 that enables the cap 3 to extend in continuity with the outside surface of the body 2.

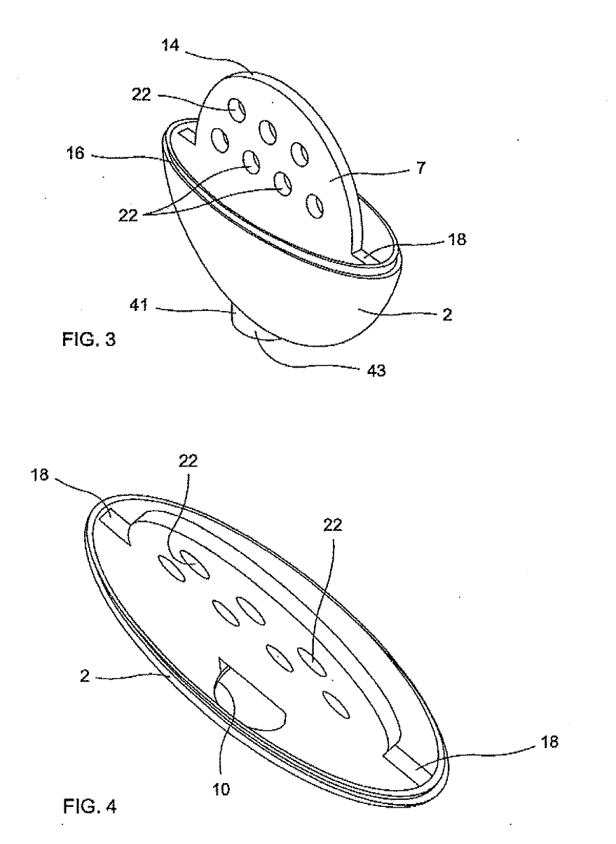

In the embodiment under consideration, over at least a fraction of its height, the body 2 presents an external cross-section that is oblong in shape, in particular substantially elliptical, as can be seen in FIGS. 3 and 4, for example.

The stiffener 7 can be connected to the body 2 via diametrically-opposite extensions 18, the stiffener 7 being flat along a plane containing the long axis of the cross-section of the body 2 in the embodiment under consideration.

At its base, the stiffener 7 can include a recess 20, as shown in FIG. 2, in register with the filler orifice.

In the embodiment under consideration, the stiffener 7 is perforated, including a plurality of holes 22 that improve the anchoring of a block 30 of a composition P on the stiffener 7.

In the embodiment under consideration, the block 30 extends above the body 2, inside the cap 3, but it is not beyond the ambit of the present invention for the block 30 also to extend inside the body 2, at least before the device 1 is used for the first time.

The composition P passes through the holes 22.

The filler orifice 5 can be formed inside a base 41 of the body 2, having a bottom end 42 that is situated in the same plane that is perpendicular to the longitudinal axis of the device 1, thereby enabling the user to stand said device on a plane horizontal surface.

By way of example, the base 41 presents an outside surface 43 that is circularly cylindrical about the axis X, as can be seen in particular in FIG. 3.

The block 30 can present various shapes and, for example, an oblong cross-section that is elongate along a long axis X₁, the dimension d₁ of the block 30 along the axis X₁ being such that the ratio d₁/d₂, where d₂ designates the dimension along the short axis X₂ that is perpendicular to X₁, lies in the range 4 to 1, for example, this range of values naturally not being limiting.

While always presenting an outside surface 39 that is free during use, the block 30 covers the stiffener 7 over a height h that varies progressively as the block is used up.

The composition P can be poured into the device via the filler orifice 5, the stopper 6 being removed and the cap being in place on the body 2, the device 1 being upsidedown.

Filling with the cap 3 in place is appropriate so long as the composition P adheres to the cap 3 little enough to avoid the block 30 being damaged when it is removed from the cap 3 for the first time.

The cap 3 can possibly be made of a material that reduces the adherence of the composition P, or it could have been subjected to a surface treatment that produces the same effect.

In a variant, the composition is poured into a mold and the body 2 is placed upsidedown onto the mold, e.g. a mold made of silicone or of any other material that enables unmolding to take place without damaging the block 30.

The composition P can be formulated in such a manner as to be fluidized easily. This can enable the user to reshape the application surface after using up a fraction of the composition P, by positioning the device 1 upsidedown and exposing the composition P, cap in place, to a source of heat, e.g. in a microwave oven. Exposing the composition P to microwaves makes it possible, in particular, to have a bactericidal effect.

In order to hold the cap 3 upsidedown while the composition P is being fluidized, the cap 3 can be made with a flat top 60, as shown in FIG. 12.

In a variant, as shown in FIG. 13, a stand 61 can be used, the stand 61 being arranged so as to hold the device 1 vertical in a cap down position.

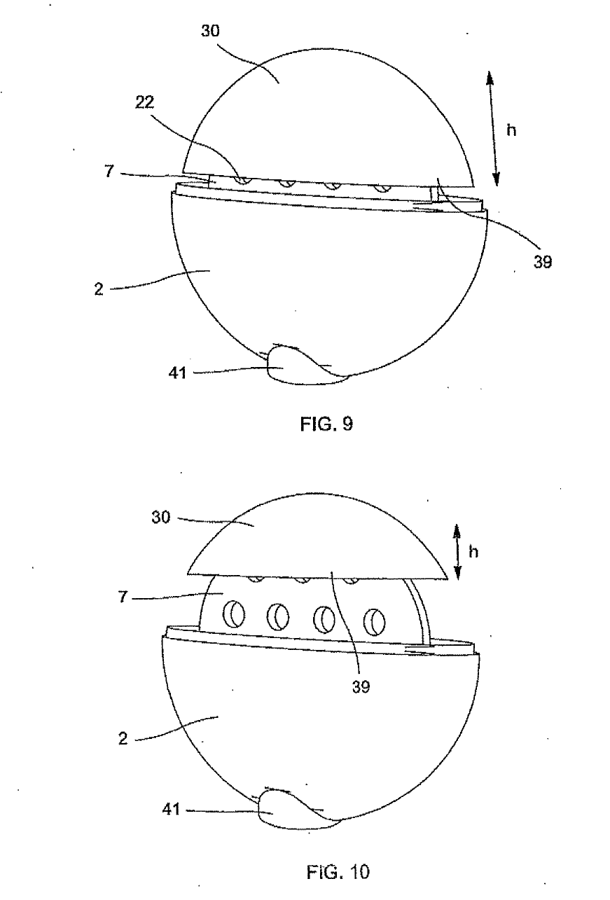

Reshaping the application surface makes it possible to have a block 30 that continues to match the shape of the inside surface of the cap as the composition P is used up progressively, as shown in FIGS. 9 to 11.

In the variant shown in FIG. 14, the device 1 includes a block 30 comprising two different compositions P₁ and P₂, each occupying substantially half the block 30, for example.

The stiffener 7 can be identical to the stiffener in the above-described embodiment. In a variant, the stiffener 7 can extend as far as the cap 3, such that its edge 64 is visible between the compositions P₁ and P₂. This makes it possible to use the stiffener 7, that need not have perforations, as a partition, so as to avoid the compositions P₁ and P₂ mixing together when they are poured into an auxiliary mold or inside the cap 3.

By way of example, one of the compositions P₁ is a composition for imparting color, while the other composition P₂ is for imparting glossiness, the two compositions being suitable for being applied one after the other, for example.

The invention is not limited to the embodiments described above.

In particular, it is possible to make the stiffener 7 with projecting portions in relief, without perforations, so as to enable the composition P to cling to the stiffener.

Where appropriate, the composition could be poured by the user into the device, the composition being produced, for example, from one or more components that are mixed in proportions that are selected by the user as a function of the desired result.

As shown in FIG. 15, the device could include an applicator 100 that acts as a stopper, for example, the applicator 100 including an applicator member 101 that is housed in the body 2 when not in use.

By way of example, the applicator member 101 could be used to perform finishing operations, and could include a felt tip, a flocked endpiece, a paint brush, foam, a brush, or a comb, amongst others. In a variant, the applicator member 101 includes, or is loaded with, a composition that is different from the composition housed in the cap 3, so as to draw an outline or impart an additional optical effect, for example.

The expression “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A packaging and applicator device for applying at least one cosmetic composition, the device comprising:
a body defining a handle;
a block of at least one cosmetic composition;
a flat stiffener that is stationary relative to the composition and that extends inside said composition, the block defining a free outside surface that extends over at least a fraction of the height of the stiffener; and
a cap that is arranged so as to be fastened on the body, and so as to cover the block.

2. A device according to claim 1, the body including a filler orifice in its side remote from the cap.

3. A device according to claim 2, including a stopper that is fastened in the filler orifice.

4. A device according to claim 3, the stopper being fastened in removable manner in the filler orifice.

5. A device according to claim 1, the stiffener being perforated.

6. A device according to claim 5, the stiffener including a plurality of holes.

7. A device according to claim 1, the body presenting an external cross-section that is oblong over at least a fraction of its height.

8. A device according to claim 1, the stiffener being molded integrally with the body.

9. A device according to claim 1, the cap being arranged so as to rest in stable manner on a plane horizontal surface while in an upsidedown position.

10. A device according to claim 1, including a stand that is independent of the cap, and on which the cap can be placed upsidedown, in stable manner.

11. A device according to claim 1, the block being formed of a single composition.

12. A device according to claim 1, the block comprising two different compositions.

13. A device according to claim 12, one of the compositions being colored and the other being for imparting glossiness.

14. A device according to claim 12, the two compositions being disposed on respective sides of a mid-plane for the stiffener.

15. A device according to claim 1, the stiffener not being in contact with the cap, when said cap is in place on the body.

16. A device according to claim 1, the stiffener coming into contact with the cap, when said cap is in place on the body.

17. A device according to claim 1, the composition being for application to the lips.

18. A device according to claim 1, the composition being fluidizable by applying heat.

19. A device according to claim 1, the composition having a melting temperature that is less than or equal to 60° C.

20. A device according to claim 1, the stiffener presenting a height, measured between the base of the initial block of composition and the top edge of the stiffener, parallel to the longitudinal axis of the stiffener, that is greater than half the initial height of the block.

21. A device according to claim 20, the height of the stiffener being greater than 70% of the initial height of the block.

22. A method of manufacturing a packaging and applicator device for applying at least one cosmetic composition, the method comprising:
a body defining a handle;
a block of at least one cosmetic composition;
a stiffener that is stationary relative to the composition and that extends inside said composition, the block defining a free outside surface that extends over at least a fraction of the height of the stiffener; and
a cap that is arranged so as to be fastened on the body, and so as to cover the block;
in which, while the cap is upsidedown and in place on the body, at least one composition is poured in fluid state through the filler orifice of the body, the cap serving as a mold so as to give the composition its shape while cooling.

23. A method of reshaping a block of at least one composition of a packaging and applicator device for applying at least one cosmetic composition, the method comprising:
a body defining a handle;
a block of at least one cosmetic composition;
a stiffener that is stationary relative to the composition and that extends inside said composition, the block defining a free outside surface that extends over at least a fraction of the height of the stiffener; and
a cap that is arranged so as to be fastened on the body, and so as to cover the block;
the method comprising the steps consisting in placing the cap upsidedown in place on the body, and in heating the composition so as to bring it to a temperature at which it becomes fluid, so that, on cooling, the composition takes on the shape of the cap.

24. A method according to claim 23, heating being performed by placing the device in a microwave oven.

25. A method of applying makeup to keratinous materials, in particular the lips, the method comprising the step consisting in bringing a surface of the block of at least one composition of a device as defined in claim 1, into contact with the keratinous materials to be made up.
